(19) United States
(12) Patent Application Publication
(10) Pub. No.: US 2024/0345019 A1
(43) Pub. Date: Oct. 17, 2024

(54) GAS SENSOR AND PRODUCTION METHOD FOR GAS SENSOR

(71) Applicant: Niterra Co., Ltd., Nagoya-shi, Aichi (JP)

(72) Inventors: Yuto INOSE, Nagoya-shi, Aichi (JP); Daisuke MATSUYAMA, Nagoya-shi, Aichi (JP); Masashi NOMURA, Nagoya-shi, Aichi (JP); Kunihiko YONEZU, Nagoya-shi, Aichi (JP)

(73) Assignee: Niterra Co., Ltd., Nagoya-shi, Aichi (JP)

(21) Appl. No.: 18/705,806

(22) PCT Filed: Dec. 21, 2022
(86) PCT No.: PCT/JP2022/047054

§ 371 Date: Apr. 29, 2024

(30) Foreign Application Priority Data
Dec. 24, 2021 (JP) 2021-210365

(51) Int. Cl. G01N 27/407

(52) U.S. Cl. CPC G01N 27/4077

(57) ABSTRACT

A gas sensor (1A) including a sensor element (21) extending in an axial-line O direction; a metal shell (11); a tubular holder (30A) located on a front-end side in a gap between an inner surface of the metal shell and an outer surface of the sensor element; a tubular sleeve (43) located on a rear-end side in the gap; a seal member (41) made from inorganic particles and filling a space between the holder and the sleeve in the gap so as to seal the gap between the metal shell and the sensor element; and a pressing portion (16) compressing the seal member in the axial-line direction, and in which a rearward displacement amount (L) of the sleeve due to expansion of the seal member when the pressing portion is removed is greater than 0 mm.

### CROSS-REFERENCE TO RELATED APPLICATIONS

This application is a National Stage of International Application No. PCT/JP2022/047054 filed Dec. 21, 2022, claiming priority based on Japanese Patent Application No. 2021-210365 filed Dec. 24, 2021.

### TECHNICAL FIELD

The present invention relates to a gas sensor in which a gap between a metal shell and a sensor element is sealed by a seal member, and a production method for the gas sensor.

### BACKGROUND ART

As a gas sensor for detecting the concentration of a specific gas component such as oxygen or NOx in intake gas or exhaust gas of an automobile or the like, a gas sensor having a sensor element using a solid electrolyte is known (Patent Document 1). This gas sensor has a metal shell surrounding the periphery of the sensor element, and a gap between the metal shell and the sensor element is sealed by a seal member made from inorganic particles such as talc.

Specifically, the gap between the metal shell and the sensor element is filled with the seal member, and a ring-shaped pressing member is provided on the rear-end side of the seal member. Then, the pressing member is pressed frontward by a crimping portion at a rear end of the metal shell, to compress the seal member frontward, thus filling the gap. When the seal member is compressed, the seal member exerts a spring-back force to expand and return to its original shape.

### PRIOR ART DOCUMENT

### Patent Document

Patent Document 1: Japanese Patent Application Laid-Open (kokai) No. 2002-228623

### SUMMARY OF THE INVENTION

### Problem to be Solved by the Invention

Here, there is a problem that sealing performance is reduced when the gas sensor undergoes a thermal cycle from a high temperature (e.g., 650° C. or higher) to the room temperature.

That is, at a high temperature, the seal member springs back so as to fill a gap formed because thermal expansion of the metal shell (crimping portion) is greater than thermal expansion of the seal member. On the other hand, at the time of cooling, the metal shell (crimping portion) greatly contracts so that the seal member is subjected to a compressive load, and therefore, as the number of thermal cycles increases, the spring-back amount of the seal member decreases. Thus, with increase in the number of thermal cycles, it becomes difficult to fill the gap between the metal shell and the seal member at a high temperature, so that sealing performance is reduced.

Accordingly, an object of the present invention is to provide a gas sensor having improved sealing performance over aging of a seal member made from inorganic particles, and a production method for the gas sensor.

### Means for Solving the Problem

The present inventor has conceived of increasing the spring-back amount of a seal member to compensate for decrease in the spring-back amount according to the number of thermal cycles, thus improving sealing performance over aging.

Then, the present inventor has found that the spring-back amount can be increased by reducing a primary particle size of inorganic particles. However, when the seal member is compressed, the inorganic particles are joined together so that the primary particle size becomes unclear. Therefore, an actual spring-back amount is prescribed.

Here, even if a displacement amount is 0, a spring-back force is present as internal stress inside the seal member, but if the displacement amount L is greater than 0, a greater spring-back force arises as compared to a case where the displacement amount is 0. Therefore, sealing performance is less likely to be reduced even if time elapses.

In order to solve the above problem, a gas sensor of the present invention is a gas sensor comprising: a sensor element extending in an axial-line direction; a metal shell which has a through hole penetrating in the axial-line direction and surrounds a periphery of the sensor element; a tubular holder located on a front-end side in a gap between an inner surface of the metal shell and an outer surface of the sensor element; a tubular sleeve located on a rear-end side in the gap; a seal member made from inorganic particles and filling a space between the holder and the sleeve in the gap so as to seal the gap between the metal shell and the sensor element; and a pressing portion compressing the seal member in the axial-line direction, wherein a rearward displacement amount L of the sleeve due to expansion of the seal member when the pressing portion is removed is greater than 0 mm.

With this gas sensor, since the spring-back amount of the seal member is increased, decrease in the spring-back amount according to the number of thermal cycles is compensated for, whereby sealing performance over aging can be improved.

The spring-back amount can be increased by reducing the primary particle size of the inorganic particles. However, when the seal member is compressed, the inorganic particles are joined together so that the primary particle size becomes unclear. Therefore, an actual spring-back amount when the pressing portion is removed is prescribed.

In the gas sensor of the present invention, the displacement amount L may be not less than 0.3 mm.

With this gas sensor, the spring-back force is further increased.

A production method for a gas sensor of the present invention is a production method for a gas sensor including a sensor element extending in an axial-line direction, a metal shell which has a through hole penetrating in the axial-line direction and surrounds a periphery of the sensor element, a tubular holder located on a front-end side in a gap between an inner surface of the metal shell and an outer surface of the sensor element, a tubular sleeve located on a rear-end side in the gap, and a seal member filling a space between the holder and the sleeve in the gap so as to seal the gap between the metal shell and the sensor element, the production method comprising: a filling step of filling the space between the holder and the sleeve in the gap with, as the seal member, inorganic particles whose average primary particle size measured by laser analysis or sieving analysis is less than 300 μm; and a pressing step of compressing the seal member in the axial-line direction.

With this production method for a gas sensor, since the spring-back amount of the seal member is increased by reducing the primary particle size of the inorganic particles, decrease in the spring-back amount according to the number of thermal cycles is compensated for, whereby sealing performance over aging can be improved.

### Advantageous Effects of the Invention

The present invention makes it possible to obtain a gas sensor having improved sealing performance over aging of a seal member made from inorganic particles.

### BRIEF DESCRIPTION OF THE DRAWINGS

FIG. 1 shows a sectional view along an axial-line direction of a gas sensor according to an embodiment of the present invention.

FIGS. 2A and 2B show a method for measuring a rearward displacement amount L of a sleeve due to expansion of a seal member when a pressing portion is removed.

FIGS. 3A-3B illustrate the relationship between an average primary particle size of inorganic particles and a spring-back amount.

FIGS. 4A-4G show a production method for the gas sensor according to the embodiment of the present invention.

FIGS. 5A and 5B show process views subsequent to FIGS. 4A-4G.

FIG. 6 is a graph showing leakage amounts of seal members when gas sensors were produced with the seal members prepared using talc powders having different average primary particle sizes.

### MODES FOR CARRYING OUT THE INVENTION

Hereinafter, an embodiment of the present invention will be described.

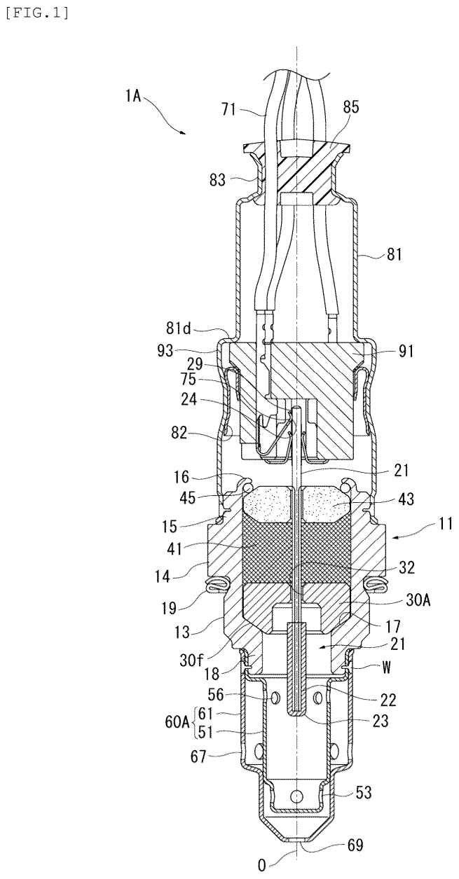

FIG. 1 is a sectional view of a gas sensor 1A according to an embodiment of the present invention.

In FIG. 1, a gas sensor (full-range air/fuel ratio gas sensor) 1 includes a sensor element 21, a holder (ceramic holder) 30A having a through hole 32 which penetrates in an axial-line-O direction and through which the sensor element 21 is inserted, a metal shell 11 surrounding the circumference in the radial direction of the ceramic holder 30A, and a protector 60A.

Of the sensor element 21, a front-end-side part where a detection portion 22 is formed protrudes frontward of the holder 30A. Thus, the sensor element 21 inserted through the through hole 32 is fixed while being kept in an airtight state in the front-rear direction inside the metal shell 11 by compressing a seal member 41 located on the rear-end-surface side (upper side in the drawing) of the holder 30A in the front-rear direction via a ring washer 45 and a (ceramic) sleeve 43 made of an insulating material.

A rear-end-29-side part including the rear end 29 of the sensor element 21 protrudes rearward of the sleeve 43 and the metal shell 11, and metal terminals 75 provided at front ends of lead wires 71 led to outside through a rubber grommet 85 are pressed in contact with electrode terminals 24 formed at the rear-end-29-side part, so as to be electrically connected thereto. The rear-end-29-side part of the sensor element 21 including the electrode terminals 24 is covered by the outer casing 81. Hereinafter, further details will be described.

The sensor element 21 has a band plate shape (plate shape) extending in the axial-line-O direction, and has, on the front-end side (lower side in the drawing) directed to a measurement target, the detection portion 22 which includes a detection electrode and the like (not shown) and detects a specific gas component in a detection target gas. The sensor element 21 has a rectangular cross-section whose size is constant along the front-rear direction, and is formed in a thin long shape, using mainly ceramic (solid electrolyte, etc.). The sensor element 21 is the same as a conventionally known one, in which a pair of detection electrodes forming the detection portion 22 are provided at a front-end-side part of the solid electrolyte (member), and continuously therefrom, the electrode terminals 24 to be connected with the lead wires 71 for taking out a detection output are formed and exposed at a rear-end-side part.

In this example, a heater (not shown) is provided inside a front-end-side part of a ceramic material laminated on the solid electrolyte (member), of the sensor element 21, and the electrode terminals 24 to be connected with the lead wires 71 for voltage application to the heater are formed and exposed at a rear-end-side part. Although not shown, the electrode terminals 24 are formed in a vertically long rectangular shape, and for example, three or two electrode terminals are side-by-side arranged at large-width surfaces (both surfaces) of the band plate, at the rear-end-29-side part of the sensor element 21.

The detection portion 22 of the sensor element 21 is coated with a porous protection layer 23 made of alumina, spinel, or the like.

The metal shell 11 has an open hole penetrating in the axial-line O direction and has a tubular shape whose front and rear sides are concentric and different in diameter. On the front-end side, the metal shell 11 has a cylindrical annular portion (hereinafter, may be referred to as cylindrical portion) 18 having a smaller diameter, and on an outer circumferential surface rearward thereof (upper side in the drawing), the metal shell 11 has a thread 13 having a larger diameter for fixation to an exhaust pipe of an engine. Further, rearward thereof, the metal shell 11 has a polygonal portion 14 to be used for screwing the sensor 1 by the thread 13.

In addition, rearward of the polygonal portion 14, contiguously thereto, the metal shell 11 has a cylindrical portion 15 to which the protection tube (outer casing) 81 for covering the rear part of the gas sensor 1 is externally fitted and welded, and rearward thereof, the metal shell 11 has a thin crimping cylindrical portion 16 having a smaller outer diameter than the cylindrical portion 15. In FIG. 1, the crimping cylindrical portion 16 has been bent inward after being crimped. A gasket 19 for sealing at the time of screwing is attached at the lower surface of the polygonal portion 14.

Further, the metal shell 11 has, on an inner circumferential surface near the annular portion 18, a taper-shaped step portion 17 tapered inward in the radial direction from the rear-end side toward the front-end side.

The crimping cylindrical portion 16 corresponds to a “pressing portion” in the claims.

On the inner side (of the open hole) of the metal shell 11, the holder 30A made of insulating ceramic (e.g., alumina) and having a substantially short cylindrical shape is provided. The holder 30A has a frontward-facing surface 30f formed in a taper shape tapered toward the front end. An outer-circumferential-side part of the frontward-facing surface 30f is engaged with the step portion 17 and the holder 30A is pressed by the seal material 41 from the rear-end side, whereby the holder 30A is clearance-fitted and positioned inside the metal shell 11.

The through hole 32 is provided at the center of the holder 30A, and is formed to be a rectangular opening having almost the same dimension as the cross-section of the sensor element 21 so that the sensor element 21 is inserted with substantially no gap therebetween.

The sensor element 21 is inserted through the through hole 32 of the holder 30A so that the front end of the sensor element 21 protrudes frontward of the front ends of the holder 30A and the metal shell 11.

A front-end part of the sensor element 21 is covered by the protector 60A which has a tubular shape and allows a measurement target gas to be introduced/discharged. In the present embodiment, the protector 60A is formed as a double-layer protector in which a bottomed cylindrical inner protector 51 having vent holes 56 and discharge holes 53, and a bottomed cylindrical outer protector 61 having vent holes 67 and discharge holes 69, are arranged separately from each other.

In a state in which rear ends 60Ae of the inner protector 51 and the outer protector 61 overlap on the outer surface of the annular portion 18, a welded portion W penetrating the inner protector 51 and the outer protector 61 is formed. More specifically, the rear end of the inner protector 51 expands in diameter to contact with the rear end of the outer protector 61, thus forming the rear ends 60Ae where both protectors overlap each other. Then, the rear end of the inner protector 51 and the outer surface of the annular portion 18 are opposed to each other, and the welded portion W is formed from the outer protector 61 toward the annular portion 18.

As shown in FIG. 1, the metal terminals 75 provided at the front ends of the lead wires 71 led to outside through the grommet 85 are, by spring property thereof, pressed in contact with the electrode terminals 24 formed at the rear-end-29-side part of the sensor element 21, so as to be electrically connected thereto. In the gas sensor 1A in this example, the metal terminals 75 including the pressed contact portions are retained in respectively opposed arrangement in storage portions provided in an insulating separator 91 placed in the outer casing 81. Movement of the separator 91 in the radial direction and the frontward direction is restricted by a metal retainer 82 crimped and fixed in the outer casing 81. The front-end part of the outer casing 81 is externally fitted and welded to the cylindrical portion 15 at the rear-end-side part of the metal shell 11, whereby the rear side of the gas sensor 1A is covered in an airtight state.

The lead wires 71 are led to outside through the grommet 85 provided inside the rear-end part of the outer casing 81, and this small diameter part 83 is crimped in a diameter reducing manner so as to compress the grommet 85, whereby this part is kept in an airtight state.

The outer casing 81 has, slightly on the rear-end side from the center in the axial-line-O direction, a step portion 81d having a larger diameter on the front-end side, and the inner surface of the step portion 81d supports and pushes the rear end of the separator 91 frontward. A flange 93 formed at the outer circumference of the separator 91 is supported on the metal retainer 82 fixed on the inner side of the outer casing 81. Thus, the separator 91 is retained in the axial-line-O direction by the step portion 81d and the metal retainer 82.

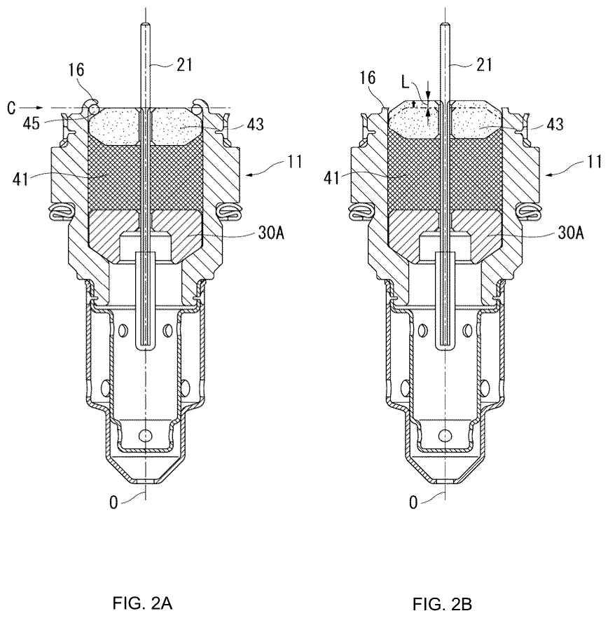

Next, with reference to FIGS. 2A-2B, a characteristic part of the gas sensor 1A of the present invention will be described.

As described above, the space between the holder 30A and the sleeve 43 in the gap between the metal shell 11 and the sensor element 21 is filled with the seal member 41. Then, the crimping cylindrical portion 16 of the metal shell 11 is bent inward to be engaged with a rearward-facing surface of the sleeve 43, and compresses the seal member 41 frontward, whereby the seal member 41 keeps the gap in an airtight state.

The seal member 41 is made from inorganic particles such as talc. The talc (powder) is a kind of silicate mineral and generally contains, as a main component (not less than 50% by mass), talc (hydrated magnesium silicate [Mg₃Si₄O₁₀(OH)₂]) obtained by crushing natural ore. As talc containing other impurities, for example, Guangxi talc containing about 0.3 to 5% by weight of impurities such as magnesite or Haicheng talc containing about 1 to 30% by weight of impurities such as magnesite and dolomite, may be used.

The seal member 41 may contain inorganic particles having another composition in addition to talc.

As described above, the spring-back amount of the seal member 41 can be increased by reducing the primary particle size of the inorganic particles. However, when the seal member 41 is compressed, the inorganic particles are joined together so that the primary particle size becomes unclear. Therefore, in the gas sensor of the present invention, an actual spring-back amount is prescribed as follows.

First, as shown in FIG. 2A, the outer casing 81 is removed from a product of the gas sensor 1A, and then the crimping cylindrical portion 16 is removed (cut) at a position C along the radial direction. At this time, the position of the rearward-facing surface of the sleeve 43 before the crimping cylindrical portion 16 is cut is measured.

When the crimping cylindrical portion 16 is cut, the seal member 41 springs back to lift the sleeve 43 rearward. Then, as shown in FIG. 2B, a rearward displacement amount L of the sleeve 41 between before and after the crimping cylindrical portion 16 is cut is measured.

In the gas sensor of the embodiment of the present invention, the displacement amount L is desirably not less than 0.3 mm.

Even if the displacement amount L is less than 0.3 mm, as compared to a case where the displacement amount is 0, the seal member 41 springs back and therefore sealing performance is high. However, the spring-back amount of the seal member 41 is small and it is difficult to compensate for decrease in the spring-back amount according to the number of thermal cycles, so that sealing performance over aging might be reduced.

The upper limit of the displacement amount L may be any value, but in view of the measurement principle for the displacement amount L in FIGS. 2A-2B, the displacement amount L cannot be measured if the seal member 41 springs back rearward relative to the cut part of the crimping cylindrical portion 16, and therefore the upper limit may be a value when the seal member 41 reaches the cut part of the crimping cylindrical portion 16.

As the primary particle size of the inorganic particles is reduced, the spring-back amount and also the displacement amount L are increased. In terms of production, the lower limit of the average primary particle size of the inorganic particles is about 10 μm. Accordingly, the upper limit of the displacement amount L may be set at 1.1 mm in terms of production.

Therefore, the displacement amount L is preferably 0.3 to 1.1 mm. From the standpoint of suppressing reduction in sealing performance over aging, the displacement amount L is more preferably 0.4 to 1.1 mm and even more preferably 0.7 to 1.1 mm.

The average primary particle size measured by laser analysis or sieving analysis is desirably less than 300 μm and the average primary particle size is more desirably not greater than 40 μm.

As the primary particle size is reduced, it is more difficult to disperse the inorganic particles when mixing them. Therefore, a binder is preferably mixed as a dispersant. The binder may be a known organic binder, and the binder may be burned out after the inorganic particles are dispersed.

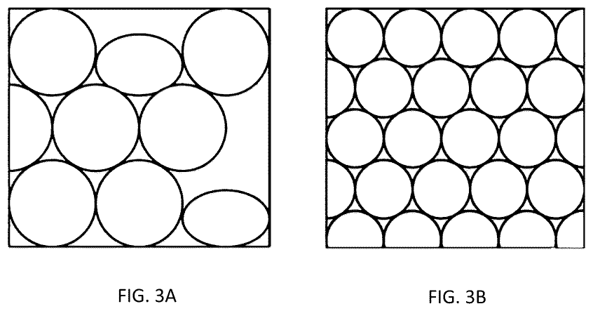

Here, with reference to FIGS. 3A-3B, the reason why the spring-back amount increases as the primary particle size of the inorganic particles is reduced, will be described.

In a case where the primary particle size of the inorganic particles is large (FIG. 3A), when a compressive load is applied to the inorganic particles (by the crimping cylindrical portion 16), some particles might be completely crushed and deformed, and such particles do not spring back, so that the spring-back amount of the entire seal member 41 also decreases.

On the other hand, in a case where the primary particle size of the inorganic particles is small (FIG. 3B), even if a compressive load is applied, the force is equally distributed over the entire seal member 41. Therefore, there are fewer particles completely crushed and deformed, so that the spring-back amount of the entire seal member 41 also increases.

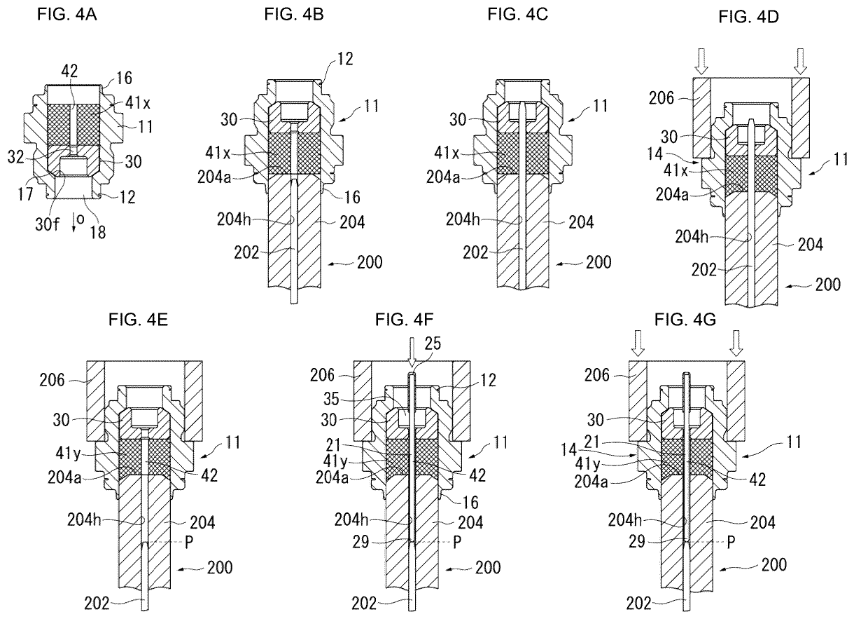

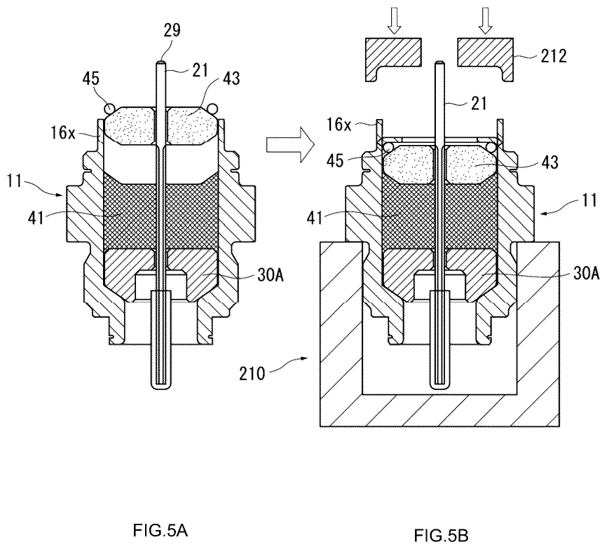

Next, with reference to FIGS. 4A-4G and FIG. 5A and FIG. 5B, a production method for the gas sensor according to the embodiment of the present invention will be described.

The production method for the gas sensor according to the embodiment of the present invention includes a filling step of filling the space between the holder 30A and the sleeve 43 in the gap between the metal shell 11 and the sensor element 21 with the inorganic particles as the seal member 43, and a pressing step of crimping a crimping original-shape portion formed on the rear-end side of the metal shell 11, frontward from the rearward-facing surface of the sleeve 43, so as to be engaged with the rearward-facing surface of the sleeve 43, thus compressing the seal member 41.

FIGS. 4A-4G show the filling step.

First, as shown in FIG. 4A, inside the metal shell 11, the holder 30A and a powder compact (talc ring) 41x formed by compacting inorganic particles are arranged in this order in the axial-line-O direction from the front-end side, and the frontward-facing surface 30f of the holder 30A is engaged with the step portion 17 (see FIG. 1). The through hole 32 of the holder 30A and a second passage hole 42 of the powder compact 41x communicate with each other with their axes aligned inside the metal shell 11. A cylindrical portion 12 side of the metal shell 11 is the “front-end side” in the axial-line-O direction, and the crimping cylindrical portion 16 side is the “rear-end side”.

Here, for facilitating handling of the inorganic powder (in this example, talc powder) forming the seal member 41, the powder compact 41x is prepared as a molded body (pellet) obtained by putting the inorganic powder in a mold and compacting the inorganic powder into a cylindrical shape having the second passage hole 42. Then, the powder compact 41x is compressed, whereby the powder flows (is rearranged) to be consolidated, thus obtaining the seal member 41 in which clearances between powder particles are densely buried.

Next, as shown in FIG. 4B, the metal shell 11 is turned upside down and put over a jig 200. The jig 200 has a cylindrical tube 204 and a metal pin 202 which is inserted in a center hole 204h of the tube 204 and moves up/down in the axial-line-O direction in the center hole 204h. The outer diameter of the tube 204 of the jig 200 is slightly smaller than the inner diameter of the crimping cylindrical portion 16 of the metal shell 11.

Therefore, when the metal shell 11 having the holder 30A and the powder compact 41x retained therein is fitted to the tube 204 from the crimping cylindrical portion 16 side, the metal shell 11 is placed on the jig 200 in a state in which the powder compact 41x is in contact with an upper surface 204a of the tube 204.

Next, as shown in FIG. 4C, the metal pin 202 is moved to protrude upward from the upper surface 204a of the tube 204, so that the metal pin 202 is inserted into the through hole 32 and the second passage hole 42. The transverse cross-section of the metal pin 202 has the same dimensions and shape (in this example, rectangle) as the transverse cross-section of the sensor element 21.

Next, as shown in FIG. 4D, a cylindrical pressing jig 206 is brought into contact with an upper surface of the polygonal portion 14 of the metal shell 11, and the pressing jig 206 is pressed downward (toward jig 200 side). Thus, the powder compact 41x is compressed by the holder 30A and the jig 200. In this step, the powder compact 41x is compressed such that a secondary powder compact 41y (see FIG. 4E) obtained by compressing the powder compact 41x has a shape that allows the metal pin 202 to be pulled out from the second passage hole 42 while the secondary powder compact 41y is pressed in contact with the inner side of the metal shell 11. Specifically, the secondary powder compact 41y is in such a compressed state that the secondary powder compact 41y does not drop by the self-weight from the metal shell 11 and keeps its shape even when the metal pin 202 is pulled out.

Thus, the powder forming the powder compact 41x flows (is rearranged) around the metal pin 202 and is consolidated while being pressed in contact with the inner side of the metal shell 11, thus obtaining the secondary powder compact 41y.

Next, as shown in FIG. 4E, the pressing force of the pressing jig 206 is eliminated and the metal pin 202 is moved down so that the metal pin 202 is pulled out from the through hole 32 and the second passage hole 42.

Next, as shown in FIG. 4F, the rear end 29 side of the sensor element 21 is inserted into the through hole 32 and the second passage hole 42 from the upper side of the metal shell 11 (the cylindrical portion 12 side which is the front-end side).

Next, as shown in FIG. 4G, the pressing jig 206 is pressed downward (toward jig 200 side). Thus, the secondary powder compact 41y is compressed by the holder 30A and the jig 200.

On the secondary powder compact 41y compressed in FIG. 4G, the pressure is thereafter released by the pressing jig 206 and the like being removed, and therefore the above spring-back force does not arise.

Next, with reference to FIGS. 5A and 5B, the pressing step will be described.

First, as shown in FIG. 5A, the metal shell 11 after the step in FIG. 4G is performed is taken out from the jig 200 and is turned upside down, and then the sleeve 43 and the ring washer 45 are inserted from the rear end 29 side of the sensor element 21. At this time, the ring washer 45 is placed at the rear end of the sleeve 43 on the inner side of the crimping original-shape portion 16x at the rear end of the metal shell 11.

Next, as shown in FIG. 5B, the metal shell 11 in this state is supported and positioned by a stationary jig 210. Then, in the supporting, a lower surface of the polygonal portion 14 of the metal shell 11 is brought into contact with a positioning portion 210a at an upper surface of the stationary jig 210. Thereafter, by a crimping die 212, the crimping original-shape portion 16x is compressed frontward to be bent inward. Thus, the crimping cylindrical portion 16 is formed and the seal member 41 is further compressed, so that the components including the sensor element 21, the sleeve 43, and the like are fixed inside the metal shell 11.

Then, by being pressed by the crimping cylindrical portion 16, the seal member 41 is compressed in a state of being constrained between the holder 30A and the sleeve 43, so that the spring-back force arises.

Thereafter, although not shown, the protector 60A is welded to the front-end side of the metal shell 11, to assemble a sensor element assembly. Further, a rear-end side assembly including the outer casing 81, which has been produced and assembled separately, and the above sensor element assembly, are combined together. Then, the front end of the outer casing 81 is externally fitted to the rear-end side of the metal shell 11 and is welded by a laser over the entire circumference. Thus, the gas sensor 1A in FIG. 1 can be produced.

In the production method for the gas sensor according to the embodiment of the present invention, filling is performed with, as the seal member 43, inorganic particles whose average primary particle size measured by laser analysis or sieving analysis is less than 300 μm, whereby the spring-back amount of the seal member 41 is increased as described above and thus sealing performance over aging of the seal member made from the inorganic particles can be improved.

In the above embodiment, the seal member 41 is pressed from the rear-end side toward the front-end side by the crimping cylindrical portion 16. However, means for pressing the seal member 41 is not limited thereto. For example, a crimping portion may be provided on the front-end side of the metal shell 11 and the seal member 41 may be pressed from the front-end side toward the rear-end side, or a pressing member as a separate body from the metal shell 11 may be fixed to the metal shell 11 with a load applied to the pressing member, so as to compress the seal member 41.

Needless to say, the present invention is not limited to the above embodiment and includes various modifications and equivalents encompassed in the idea and the scope of the present invention.

Examples of the gas sensor include, besides a NOx sensor, an oxygen sensor and a full-range air/fuel ratio sensor.

The sensor element is not limited to a plate shape and may be a tubular element.

### Examples

A seal member was prepared using talc powder whose average primary particle size measured by laser analysis was 23.7 μm. Raw material powder for the talc powder, with ethanol added as a binder, was crushed by a ball mill, to obtain the above average primary particle size.

This powder was shaped into the above powder compact and then was provided to fill the gap between the metal shell 11 and the sensor element 21 as shown in FIGS. 4A-4G and FIGS. 5A and 5B, and the crimping cylindrical portion 16 was crimped, to produce the gas sensor 1A.

For comparison, a seal member was prepared in the same manner using talc powder whose average primary particle size measured by sieving analysis was not less than 300 μm, to produce the gas sensor 1A.

For the obtained gas sensors, a leakage amount after a submergence test was measured to evaluate sealing performance over aging of the seal member 41.

Specifically, 800 thermal cycles, in each of which “the polygonal portion 14 was sharply cooled from 450° C. by ordinary-temperature water”, were performed. Thereafter, a measurement gas at a predetermined temperature and a predetermined pressure (0.4 MPa in gauge pressure) was supplied from one end side of the gas sensor for a predetermined period, and the measurement gas leaked out from the other end side of the gas sensor was collected by water displacement, whereby the leakage amount was measured.

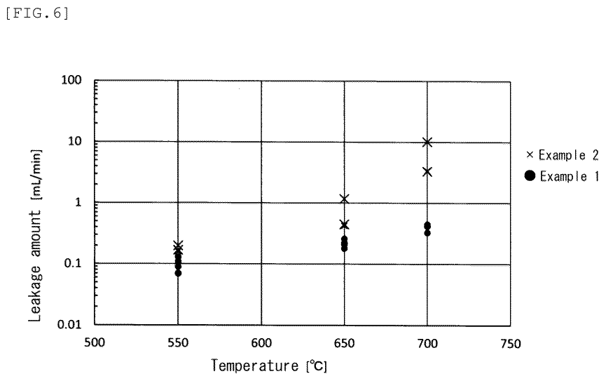

FIG. 6 shows the obtained result.

In Example 1 in which the average primary particle size was small, even after the above thermal cycles between the high temperature of 450° C. and the room temperature were performed, the leakage amount was small and sealing performance over aging was improved, as compared to Example 2 in which the average primary particle size was large.

The temperature in FIG. 6 is the temperature of the metal shell 11 when the gas sensor was kept in a high-temperature atmosphere.

When the temperature in FIG. 6 was 700° C., the leakage amount in Example 1 was about 0.4 ml/min, and the leakage amount in Example 2 was not less than about 3 ml/min.

The displacement amount L in Example 1 after the above thermal cycles, which was measured as shown in FIG. 2A-2B, was 0.70 mm. The displacement amount L in Example 2 was 0.29 mm.

### DESCRIPTION OF REFERENCE NUMERALS

1A gas sensor
11 metal shell
16 crimping cylindrical portion (pressing portion)
21 sensor element
30A holder
41 seal member
3 sleeve
O axial-line

1. A gas sensor comprising:
a sensor element extending in an axial-line direction;
a metal shell which has a through hole penetrating in the axial-line direction and surrounds a periphery of the sensor element;
a tubular holder located on a front-end side in a gap between an inner surface of the metal shell and an outer surface of the sensor element;
a tubular sleeve located on a rear-end side in the gap;
a seal member made from inorganic particles and filling a space between the holder and the sleeve in the gap so as to seal the gap between the metal shell and the sensor element; and
a pressing portion compressing the seal member in the axial-line direction, wherein
a rearward displacement amount L of the sleeve due to expansion of the seal member when the pressing portion is removed is greater than 0 mm.

2. The gas sensor according to claim 1, wherein
the displacement amount L is not less than 0.3 mm.

3. A production method for a gas sensor including
a sensor element extending in an axial-line direction,
a metal shell which has a through hole penetrating in the axial-line direction and surrounds a periphery of the sensor element,
a tubular holder located on a front-end side in a gap between an inner surface of the metal shell and an outer surface of the sensor element,
a tubular sleeve located on a rear-end side in the gap, and
a seal member filling a space between the holder and the sleeve in the gap so as to seal the gap between the metal shell and the sensor element,
the production method comprising:
a filling step of filling the space between the holder and the sleeve in the gap with, as the seal member, inorganic particles whose average primary particle size measured by laser analysis or sieving analysis is less than 300 μm; and
a pressing step of compressing the seal member in the axial-line direction.
